(19) United States
(12) Patent Application Publication
(10) Pub. No.: US 2010/0268542 A1
(43) Pub. Date: Oct. 21, 2010

(54) APPARATUS AND METHOD OF AUDIO ENCODING AND DECODING BASED ON VARIABLE BIT RATE

(75) Inventors: Mi-Young Kim, Hwaseong-si (KR); Ho-Sang Sung, Yongin-si (KR); Eun-Mi Oh, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., SUWON-SI (JP)

(21) Appl. No.: 12/762,630

(22) Filed: Apr. 19, 2010

(30) Foreign Application Priority Data
Apr. 17, 2009 (KR) 10-2009-0033840

(51) Int. Cl. G10L 19/04

(52) U.S. Cl. 704/501; 704/E19.022

(57) ABSTRACT

An apparatus and method of audio encoding and decoding based on a Variable Bit Rate (VBR) is provided. The audio encoding and decoding apparatus and method may determine an optimum bit rate per superframe and per frame, determine an optimum encoding mode by applying an open-loop mode/closed-loop mode based on a characteristic of an audio signal, and perform indexing based on the optimum encoding mode.

### CROSS-REFERENCE TO RELATED APPLICATIONS

This application claims the priority benefit of Korean Patent Application No. 10-2009-0033840, filed on Apr. 17, 2009, in the Korean Intellectual Property Office, the disclosure of which is incorporated herein by reference.

### BACKGROUND

1. Field

Exemplary embodiments relate to an apparatus and method of encoding and decoding an audio signal by applying a Variable Bit Rate (VBR) to each frame.

2. Description of the Related Art

A speech encoder may extract parameters associated with a model of human speech generation to compress speech. Also, a speech encoder may divide inputted speech signal into time blocks or analysis frames. In general, a speech encoder may include an encoding apparatus and a decoding apparatus.

An encoding apparatus may extract related parameters, analyze an inputted speech frame, and quantize the extracted parameters to be represented in binary, for example, a set of bits or a binary data packet. The data packet may be transmitted to a receiver and a decoding apparatus through a communication channel. The decoding apparatus may process the data packet, generate the parameters through dequantization of the processed data packet, and reproduce speech frames using the dequantized parameters.

Currently, a method that may determine an optimum bit rate per superframe including a plurality of frames, determine an optimum encoding mode, and efficiently perform indexing with respect to each frame based on the optimum bit rate and the optimum encoding mode is desired.

Also, an apparatus that may unify encoding and decoding of a speech and an audio signal is desired, and a technology of a Unified Speech & Audio Coding (USAC) has been recently standardized. Also, a method that may determine an optimum bit rate per superframe including a plurality of frames, and determine an optimum encoding mode to efficiently perform indexing with respect to each frame based on the optimum bit rate and the optimum encoding mode may be required.

### SUMMARY

According to exemplary embodiments, there may be provided a bit rate determination apparatus that determines a Variable Bit Rate (VBR) to encode an audio signal, the bit rate determination apparatus including: a first bit rate determination unit to determine an optimum bit rate per superframe using a bit reservoir and a basic bit rate based on a target bit rate using at least one processor; and a second bit rate determination unit to determine an optimum bit rate per frame using the optimum bit rate per superframe.

The first bit rate determination unit may include a basic bit rate setting unit to set the basic bit rate that does not exceed the target bit rate; a bit reservoir update unit to update the bit reservoir using previously used bit amount; and an optimum bit rate determination unit to determine the optimum bit rate per superframe based on the basic bit rate and the bit reservoir.

The second bit rate determination unit may include a target bit rate determination unit to determine a target bit rate for each frame using the optimum bit rate per superframe; a bit reservoir calculation unit to calculate a local bit reservoir using a bit stored for each frame; and a bit rate determination unit to determine the optimum bit rate per frame using the local bit reservoir and the target bit rate for each frame.

According to exemplary embodiments, there may be provided an encoding mode selection apparatus, including: a Voice Activity Detection (VAD) unit to analyze a characteristic of an audio signal and to detect a voice activity; and a mode selection unit, using at least one processor, to determine an optimum group of an encoding mode with respect to the audio signal by applying an open-loop mode based on the characteristic of the audio signal, and to select an optimum encoding mode by applying a closed-loop mode to the encoding mode included in the optimum group, wherein the encoding mode includes a Transform Coded eXcitation (TCX) mode, an Algebraic Code Excited Linear Prediction (ACELP) mode, a Low-Energy Noise (LEN) mode, and a unvoiced (UV) mode to encode an audio signal according to a superframe including a plurality of frames.

According to exemplary embodiments, there may be provided an index encoding apparatus, including: a flag indexing unit, using at least one processor, to index a VBR flag with respect to a superframe including a plurality of frames, the VBR flag indicating whether information about a bit rate mode which is set for each frame exists, the plurality of frames being set as an optimum indexing mode; an ACELP core mode indexing unit to index an ACELP core mode indicating a bit rate mode which is set for the superframe; and a VBR core mode indexing unit to index a VBR core mode using the VBR flag and the ACELP core mode, the VBR core mode indicating the bit rate mode for each frame.

The index encoding apparatus may encode the index, and the index may include a VBR flag to indicate whether information about a bit rate mode set for each frame exists with respect to a superframe including a plurality of frames, the plurality of frames being set as an optimum indexing mode; an ACELP core mode to indicate a bit rate mode which is set for the superframe; and a VBR core mode to indicate a bit rate mode for each frame.

According to exemplary embodiments, there may be provided an audio signal encoding apparatus, including: a first bit rate determination unit to determine an optimum bit rate per superframe using a bit reservoir and a basic bit rate based on a target bit rate using at least one processor; a VAD unit to analyze a characteristic of an audio signal and to detect a voice activity; a second bit rate determination unit to determine an optimum bit rate per frame using the optimum bit rate per superframe; a mode selection unit to determine an optimum group of an encoding mode with respect to the audio signal by applying an open-loop mode based on the characteristic of the audio signal, and to select an optimum encoding mode by applying a closed-loop mode to the encoding mode included in the optimum group; and an index encoding unit to index a bit rate based on the optimum encoding mode.

According to example exemplary embodiments, there may be provided an index decoding apparatus including a decoding unit which uses at least one processor to decode an index where a bit rate mode is encoded, wherein the index may include a VBR flag to indicate whether information about a bit rate mode set for each frame exists with respect to a superframe including a plurality of frames, the plurality of frames being set as an optimum indexing mode; an ACELP core mode to indicate a bit rate mode which is set for the superframe; and a VBR core mode to indicate a bit rate mode for each frame.

According to exemplary embodiments, there may be provided a Unified Speech and Audio Coding (USAC) apparatus that encodes a speech and an audio signal, the USAC apparatus including: a signal classification unit to classify an input signal using at least one processor; a stereo encoding unit to encode a stereo signal when the input signal is a stereo signal; a high frequency encoding unit to encode a high frequency of the input signal; a first bit rate determination unit to determine an optimum bit rate per superframe, when the input signal is encoded in a frequency domain or a Linear Prediction (LP) domain; a frequency domain encoding unit to encode the input signal in the frequency domain; an LP domain encoding unit to encode the input signal in the LP frequency domain; a quantization unit to quantize the input signal, encoded in the frequency domain or the LP domain; and a lossless encoding unit to losslessly encode the quantized input signal.

According to exemplary embodiments, there may be provided a USAC apparatus that decodes a speech and an audio signal, the USAC apparatus including: a lossless decoding unit to losslessly decode an encoded signal; a dequantization unit to dequantize the losslessly decoded signal using at least one processor; a frequency domain decoding unit to decode the dequantized signal in a frequency domain; an LP domain decoding unit to decode the dequantized signal in an LP frequency domain; a high frequency signal decoding unit to decode a high frequency signal of the signal decoded in the frequency domain and the LP domain; and a stereo decoding unit to decode the signal, decoded in the frequency domain and the LP domain, into a stereo signal.

According to exemplary embodiments, there may be provided a bit rate determination method that determines a VBR to encode an audio signal, the bit rate determination method including: determining an optimum bit rate per superframe using a bit reservoir and a basic bit rate based on a target bit rate; and determining an optimum bit rate per frame using the optimum bit rate per superframe, wherein the method may be performed using at least one processor.

According to exemplary embodiments, there may be provided an encoding mode selection method, including: analyzing a characteristic of an audio signal and detecting a voice activity; and determining an optimum group of an encoding mode with respect to the audio signal by applying an open-loop mode based on the characteristic of the audio signal, and selecting an optimum encoding mode by applying a closed-loop mode to the encoding mode included in the optimum group, wherein the encoding mode includes a TCX mode, an ACELP mode, a LEN mode, and a UV mode to encode an audio signal according to a superframe including a plurality of frames, and wherein the method may be performed using at least one processor.

According to exemplary embodiments, there may be provided an index encoding method, including: indexing a VBR flag with respect to a superframe including a plurality of frames, the VBR flag indicating whether information about a bit rate mode set for each frame exists, the plurality of frames being set as an optimum indexing mode; indexing an ACELP core mode indicating a bit rate mode set for the superframe; and indexing a VBR core mode using the VBR flag and the ACELP core mode, the VBR core mode indicating the bit rate mode for each frame, wherein the method may be performed using at least one processor.

According to exemplary embodiments, there may be provided an audio signal encoding method, including: determining an optimum bit rate per superframe using a bit reservoir and a basic bit rate based on a target bit rate; analyzing a characteristic of an audio signal and detecting a voice activity; determining an optimum bit rate per frame using the optimum bit rate per superframe; determining an optimum group of an encoding mode with respect to the audio signal by applying an open-loop mode based on the characteristic of the audio signal, and selecting an optimum encoding mode by applying a closed-loop mode to the encoding mode included in the optimum group; and indexing a bit rate based on the optimum encoding mode, wherein the method may be performed using at least one processor.

According to another aspect of exemplary embodiments, there is provided at least one computer readable recording medium storing computer readable instructions to implement methods of the disclosure.

Additional aspects of exemplary embodiments will be set forth in part in the description which follows and, in part, will be apparent from the description, or may be learned by practice of exemplary embodiments.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 illustrates a block diagram of an audio signal encoding apparatus according to exemplary embodiments;

FIG. 2 illustrates a flowchart of an operation of determining an optimum bit rate per superframe and per frame according to exemplary embodiments;

FIG. 3 illustrates a flowchart of an operation of selecting an optimum encoding mode through a voice activity detection unit and a mode selection unit according to exemplary embodiments;

FIG. 4 illustrates a flowchart of an operation of selecting an optimum encoding mode using an open-loop mode and a closed-loop mode according to exemplary embodiments;

FIG. 5 illustrates an example of a configuration of an index, encoded when an Algebraic Code Excited Linear Prediction/Transform Coded eXcitation (ACELP/TCX) mode is an optimum encoding mode, according to exemplary embodiments;

FIG. 6 illustrates another example of a configuration of an index, encoded when an ACELP/TCX mode is an optimum encoding mode, according to exemplary embodiments;

FIG. 7 illustrates an example of a configuration of an index, encoded when an ACELP/TCX/Unvoiced/Low-Energy Noise (ACELP/TCX/UV/LEN) mode is an optimum encoding mode, according to exemplary embodiments;

FIG. 8 illustrates a block diagram of a configuration of an Unified Speech and Audio Coding (USAC) apparatus that encodes a speech and an audio signal according to exemplary embodiments; and

FIG. 9 illustrates a block diagram of a configuration of a USAC apparatus that decodes a speech and an audio signal according to exemplary embodiments.

### DETAILED DESCRIPTION

Reference will now be made in detail to exemplary embodiments, examples of which are illustrated in the accompanying drawings, wherein like reference numerals refer to the like elements throughout. Exemplary embodiments are described below to explain the present disclosure by referring to the figures.

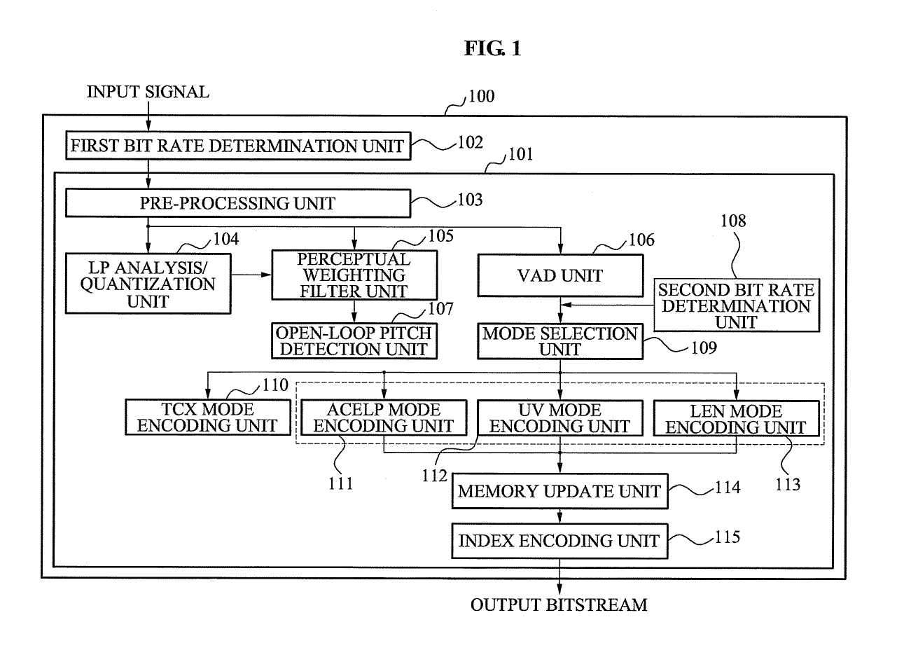

FIG. 1 illustrates a block diagram of an audio signal encoding apparatus 100 according to exemplary embodiments.

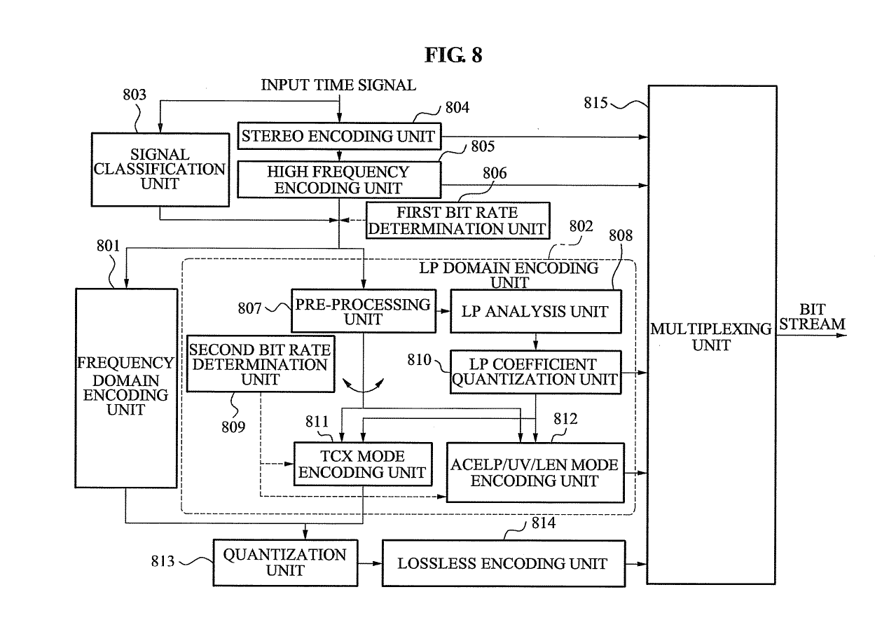

Referring to FIG. 1, the audio signal encoding apparatus 100 may include a linear prediction (LP) domain encoding apparatus 101 and a first bit rate determination unit 102, which may include at least one processor. Specifically, the LP domain encoding apparatus 101 may include a pre-processing unit 103, an LP analysis/quantization unit 104, a perceptual weighting filter unit 105, a Voice Activity Detection (VAD) unit 106, an open-loop pitch detection unit 107, a second bit rate determination unit 108, a mode selection unit 109, a Transform Coded eXcitation (TCX) mode encoding unit 110, an Algebraic Code Excited Linear Prediction (ACELP) mode encoding unit 111, an Unvoiced (UV) mode encoding unit 112, a Low Energy Noise (LEN) mode encoding unit 113, a memory update unit 114, and an index encoding unit 115. The audio signal encoding apparatus 100 may be a Unified Speech and Audio enCoder (USAC) that may unify audio and speech to process, in FIG. 8. The LP domain encoding apparatus 101 may correspond to an LP domain encoding unit 802 in FIG. 8.

The audio signal encoding apparatus 100 may encode an audio signal per superframe including a plurality of frames. For example, the superframe may include four frames. That is, a superframe may be encoded by encoding four frames. For example, when a size of a superframe corresponds to 1024 samples, a size of each of the four frames may be 256 frames. In this instance, the size of the superframe may be increased and overlapped through an OverLap and Add (OLA) method.

The first bit rate determination unit 102 may determine a bit rate per superframe for encoding in a frequency domain or a linear prediction domain. For example, the first bit rate determination unit 102 may be located outside of the LP domain encoding apparatus 101, and be function as a switch.

For example, the first bit rate determination unit 102 may determine an optimum bit rate per superframe using a bit reservoir and a basic bit rate based on a target bit rate. Although not illustrated in FIG. 1, the first bit rate determination unit 102 may include a basic bit rate setting unit, a bit reservoir update unit, and an optimum bit rate determination unit.

The basic bit rate setting unit may set the basic bit rate that does not exceed the target bit rate.

The bit reservoir update unit may update the bit reservoir to be used in a current frame, using a bit amount used in a previous frame. For example, when a bit reservoir is significantly used when a previous frame is encoded, the bit reservoir update unit may update the bit reservoir to enable the bit reservoir to be negligibly used when a current frame is encoded.

The optimum bit rate determination unit may determine the optimum bit rate per superframe based on the basic bit rate and the bit reservoir. In this instance, the optimum bit rate per superframe may be indexed as an ACELP core mode (ACELP_CORE_MODE). For example, eight bit rates may be an optimum bit rate, and the optimum bit rate may be represented in an ACELP core mode with three bits. For example, an optimum bit rate may be 768 bits/superframe, 898 bits/superframe, 1024 bits/superframe, 1152 bits/superframe, 1280 bits/superframe, 1472 bits/superframe, 1632 bits/superframe, and 1856 bits/superframe.

The pre-processing unit 103 may adjust a frequency characteristic to encode an audio signal by removing an undesired frequency component from an input signal and filtering. For example, the pre-processing unit 103 may use a pre-emphasis filtering of an Adaptive Multi Rate WideBand (AMR-WB). Here, the input signal may have a predetermined sampling frequency appropriate for encoding. For example, a narrowband speech encoder may have a sampling frequency of 8000 Hz, and a broadband speech encoder may have a sampling frequency of 16000 Hz. In this instance, it is apparent that any sampling frequency, available in an encoding apparatus, may be used. The input signal filtered through the pre-processing unit 101 may be inputted to the LP analysis/quantization unit 104.

The LP analysis/quantization unit 104 may extract an LP coefficient from the filtered input signal. Here, the LP analysis/quantization unit 104 may perform quantization using a variety of quantization schemes such as a vector quantizer, after transforming the LP coefficient into a value which is appropriate for quantization such as an Immittance Spectral Frequencies (ISF) or a Line Spectral Frequencies (LSF). A quantization index, determined through the quantization of the LP coefficient, may be transmitted to the index encoding unit 115. Also, the extracted LP coefficient and the quantized LP coefficient may be transmitted to the perceptual weighting filter unit 105.

The perceptual weighting filter unit 105 may filter the pre-processed signal through a perceptual weighting filter. The perceptual weighting filter unit 105 may reduce a quantization noise to be in a range of masking to use a masking effect of a human hearing system. The signal, filtered through perceptual weighting filter unit 105, may be transmitted to the open-loop pitch detection unit 107.

The open-loop pitch detection unit 107 may detect an open-loop pitch using the signal filtered through the perceptual weighting filter unit 105.

The VAD unit 106 may receive the signal, filtered through the pre-processing unit 101, analyze a characteristic of the filtered audio signal, and detect a voice activity. For example, the characteristic of the signal may include tilt information of a frequency domain, an energy of each utterance band, and the like.

The mode selection unit 109 may determine an optimum group of an encoding mode with respect to the audio signal by applying an open-loop mode based on the characteristic of the audio signal, and also may select an optimum encoding mode by applying a closed-loop mode to the encoding mode included in the optimum group.

The mode selection unit 109 may divide an audio signal of a current frame before selecting the optimum encoding mode. That is, the mode selection unit 109 may classify an audio signal of a current frame into an LEN, a noise, a UV, and a remaining signal using a UV detection result. In this instance, the mode selection unit 106 may select an encoding mode to be used in the current frame based on a result of the classification. The encoding mode may include a TCX mode, an ACELP mode, an LEN mode, and a UV mode to encode the audio signal of a superframe including a plurality of frames.

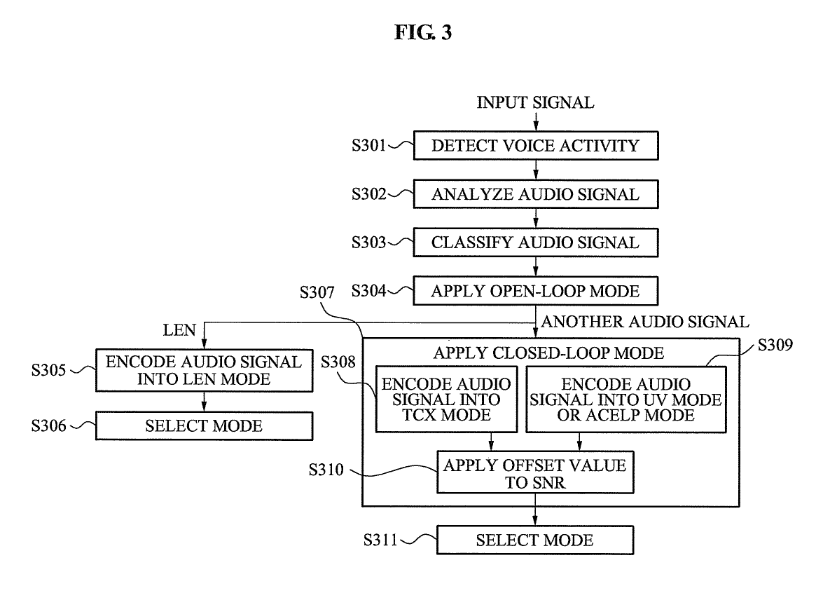

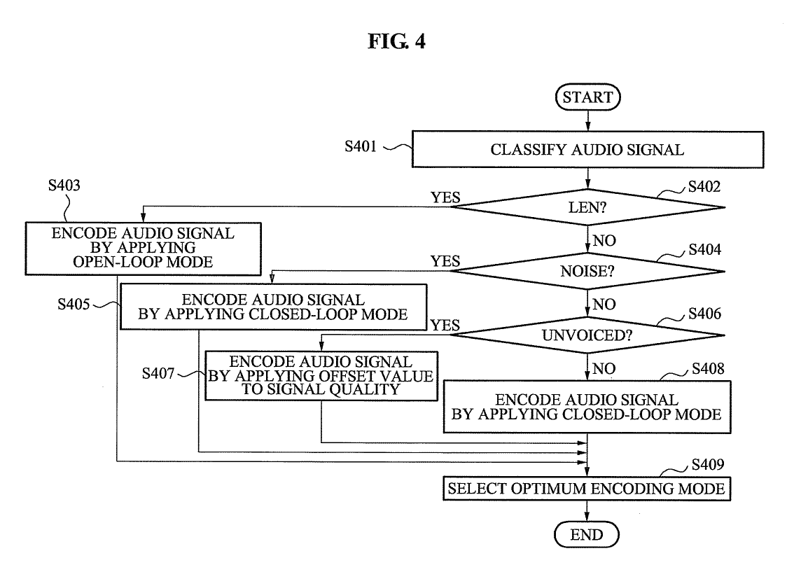

For example, the mode selection unit 109 may select the optimum encoding mode through a closed-loop when the audio signal is a voice signal and an unvoiced signal. Also, the mode selection unit 109 may select the optimum encoding mode through an open-loop when the audio signal is an LEN. An operation of selecting the optimum encoding mode is described in greater detail with reference to FIGS. 3 and 4.

The TCX mode encoding unit 110 may include three modes. The three modes may be classified based on a size of frame. For example, a TCX mode may include three modes having sizes of 256, 512, and 1024.

Referring to FIG. 1, the ACELP mode encoding unit 111, the UV mode encoding unit 112, and the LEN mode encoding unit 113 may be classified as a Code-Excited Linear Prediction (CELP) encoding unit. In this instance, all frames used in the CELP encoding unit may have a size of 256 samples.

The mode selection unit 109 may post-process the selected encoding mode. For example, the mode selection unit 109 may constrain the selected encoding mode as a first post-processing. The first post-processing may maximize a sound quality of a finally encoded signal by preventing modes from being inappropriately combined. For example, when each frame of a superframe is encoded, and when a single frame of an ACELP mode or a TCX mode is processed after a frame of an LEN mode or a UV mode, and then a frame of the LEN mode or the UV mode appears again, the frame of the second LEN mode or the second UV mode may be forcibly transformed into the frame of the ACELP mode or the TCX mode through the above-described constraint. In the first post-processing, when only single frame of the ACELP mode or the TCX mode appears, a mode may change before encoding, which may affect a sound quality. Accordingly, the first post-processing may be used to prevent a short frame of the ACELP mode or TCX mode.

As a second post-processing, the mode selection unit 109 may temporarily change an encoding mode during mode conversion. That is, when a frame of an ACELP mode or a TCX mode appears after a frame of an LEN mode or a UV mode, an encoding mode with respect to a single subsequent frame may be selected regardless of an ACELP core mode (ACELP_CORE_MODE) described below. For example, it may be assumed that 0 to 7 modes of a frame, that may be encoded for a frame of the ACELP mode or TCX mode, exist. When the ACELP core mode indicating a mode of a current frame is a mode 1, a final mode of the current frame may be selected from current modes +1 through 6, when the above-described condition is satisfied.

As a third post-processing, the mode selection unit 109 may enable a frame of an LEN mode or a UV mode to be activated only in a low bit rate. A sound quality may be more significant than a bit rate when a bit rate is greater than a predetermined value. In this instance, the third post-processing may be degraded with respect to a high bit rate in terms of an entire sound quality. Accordingly, the frame may be encoded using the only frame of the ACELP mode or TCX mode, which may be selected by a an operator. For example, when encoding is performed at 300 bits per frame or less including 256 frames, a frame of an LEN mode or a UV mode may be used. When encoding is performed at 300 or more bits, only the frame of an ACELP mode or TCX mode may be used.

As a fourth post-processing, the mode selection unit 109 may immediately change an encoding mode by ascertaining a characteristic of a current frame. That is, when a current frame has a low periodicity such as an onset or transition although encoding of the current frame is determined as a frame of an ACELP mode or TCX mode, the encoding may affect a performance. Accordingly, encoding may be performed at a temporarily high bit rate regardless of ACELP core mode. For example, it may be assumed that 0 to 7 modes of a frame, that may be encoded for the frame of the ACELP mode or TCX mode, exist. In this instance, when the ACELP core mode is a mode 1, a final mode of the current frame may be selected from current modes +1 through 6, when the above-described condition such as onset or transition is satisfied.

The memory update unit 114 may update a state of each filter used for encoding. Also, the index encoding unit 115 may perform encoding by indexing transmitted data, transform the data into a bitstream, and store the bitstream in a storage device or transmit the bitstream through a channel.

For example, although it is not illustrated in FIG. 1, the index encoding unit 115 may include a flag indexing unit, an ACELP core mode indexing unit, a Variable Bit Rate (VBR) core mode indexing unit.

The flag indexing unit may index a VBR flag with respect to a superframe including a plurality of frames. The VBR flag may indicate whether information about a bit rate mode which is set for each frame exists. Here, the plurality of frames may be set as an optimum indexing mode.

The ACELP core mode indexing unit may index an ACELP core mode (ACELP_CORE_MODE) indicating a bit rate mode set for the superframe.

The VBR core mode indexing unit may index a VBR core mode (VBR_CORE_MODE) using the VBR flag and the ACELP core mode. The VBR core mode may indicate the bit rate mode for each frame.

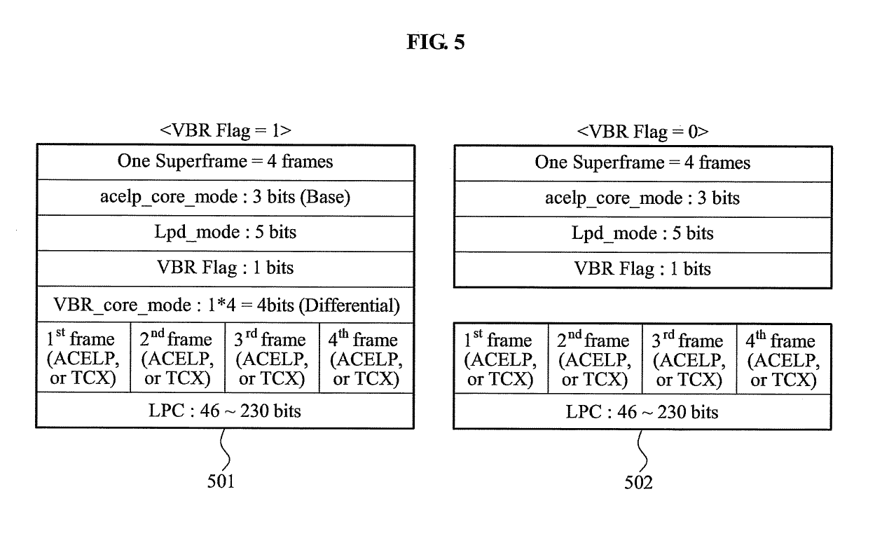

An operation of the index encoding unit 112 is described in detail with reference to FIGS. 5 through 7.

That is, the audio signal encoding apparatus 100 may determine an optimum bit rate and an optimum encoding mode, and perform indexing for each frame.

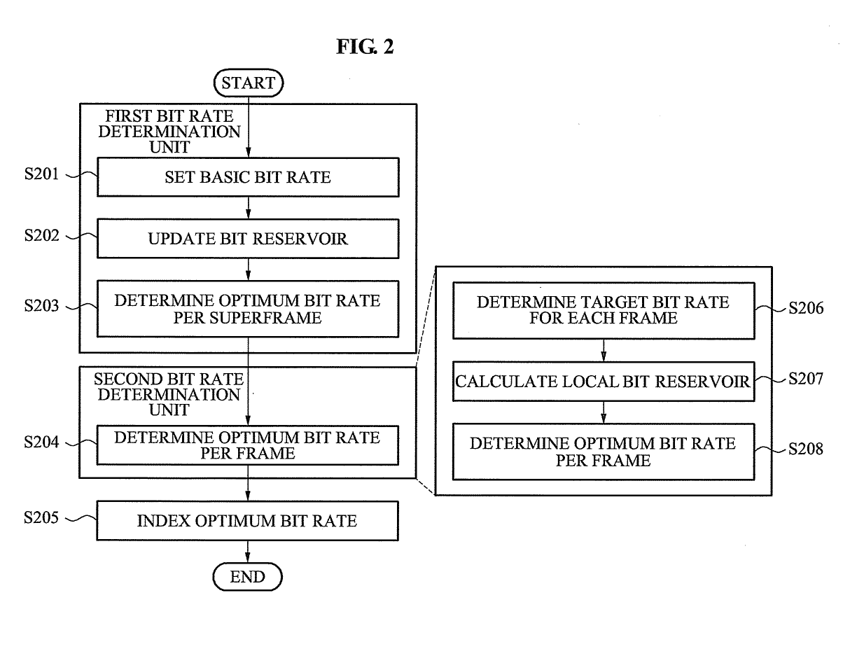

FIG. 2 illustrates a flowchart of an operation of determining an optimum bit rate per superframe and per frame according to exemplary embodiments. Referring to FIG. 2, a first bit rate determination unit may determine an optimum bit rate per superframe, and a second bit rate determination unit may determine an optimum bit rate per frame. In this instance, the first bit rate determination unit may determine a bit rate per superframe to perform encoding in a frequency domain or an LP domain.

The first bit rate determination unit may perform operations S201, S202, and S203. The first bit rate determination unit may be located outside of an LP domain encoding apparatus.

In operation S201, the first bit rate determination unit may set a basic bit rate that does not exceed a target bit rate. That is, the basic bit rate may be equal to or less than the target bit rate.

In operation S202, the first bit rate determination unit may update a bit reservoir using a bit amount used in a previous frame.

In operation S203, the first bit rate determination unit may determine the optimum bit rate per superframe based on the basic bit rate and the bit reservoir. In this instance, eight bit rate modes may be the optimum bit rate, and the optimum bit rate may be represented as an ACELP core mode of three bits.

The second bit rate determination unit, located in the LP domain encoding apparatus, may perform an operation S204. For example, the operation S204 may include operations S206, S207, and S208.

In operation S204, the second bit rate determination unit may determine an optimum bit rate per frame using the optimum bit rate per superframe.

In operation S206, the second bit rate determination unit may determine a target bit rate for each frame using the optimum bit rate per superframe.

In operation S207, the second bit rate determination unit may calculate a local bit reservoir using a bit stored for each frame.

In operation S208, the second bit rate determination unit may determine the optimum bit rate per frame using the local bit reservoir and the target bit rate for each frame. Also, the second bit rate determination unit may determine the optimum bit rate using encoding mode information of previous frames.

In operation S205, an index encoding unit may index and encode the optimum bit rate, determined by the first bit rate determination unit, and the optimum bit rate determined by the second bit rate determination unit.

FIG. 3 illustrates a flowchart of an operation of selecting an optimum encoding mode through a VAD unit and a mode selection unit according to exemplary embodiments.

In operation S301, the VAD unit may analyze a characteristic of an audio signal and detect a voice activity. The audio signal is an input signal.

In operation S302, the mode selection unit may analyze the audio signal. In operation S303, the mode selection unit may classify the audio signal. For example, the mode selection unit may classify the audio signal into an LEN signal, a noise signal, an unvoiced signal, and a remaining signal. 3

In this instance, the mode selection unit may determine an optimum group of an encoding mode with respect to the audio signal by applying an open-loop mode based on the characteristic of the audio signal, and select an optimum encoding mode by applying a closed-loop mode to the encoding mode included in the optimum group. In this instance, the encoding mode may include a TCX mode, an ACELP mode, an LEN mode, and a UV mode to encode the audio signal of a superframe including a plurality of frames.

In operation S304, the mode selection unit may select the open-loop mode. Specifically, the mode selection unit may determine whether the characteristic of the classified audio signal is an LEN.

In operation S306, when the audio signal is a low energy signal, the mode selection unit may encode the audio signal into an LEN mode using the open-loop mode. In operation S307, the mode selection unit may select the LEN mode as the optimum encoding mode.

In operation S308, the mode selection unit may select a closed-loop mode and determine an optimum group of an audio signal which is different from the low energy signal.

In operation S309, the mode selection unit may encode the audio signal into a TCX mode. In operation S310, the mode selection unit may encode the audio signal into a UV mode or an ACELP mode. In operation S311, the mode selection unit may compare results of the encoding by applying an adaptive offset value to a Signal to Noise Ratio (SNR). In operation S312, the mode selection unit may select the optimum encoding mode.

That is, the mode selection unit may encode a frame of the audio signal at a same bit rate with respect to the encoding mode included in the optimum group, and applies the closed-loop mode which selects the optimum encoding mode by comparing a signal quality of the encoded audio signal. In this instance, the signal quality of the audio signal may be determined using the SNR. That is, when the closed-loop mode is applied, the mode selection unit may select, as the optimum encoding mode, an encoding mode, having a greatest signal quality, by encoding using two encoding modes and comparing an SNR of the encoded result. Here, the two encoding modes may be determined based on a characteristic of the audio signal.

FIG. 4 illustrates a flowchart of an operation of selecting an optimum encoding mode using an open-loop mode and a closed-loop mode according to exemplary embodiments.

In operation S401, a mode selection unit may classify an audio signal based on a characteristic of the audio signal. Specifically, the audio signal may be classified into an LEN, a UV, a noise, and a remaining signal.

In operation S402, the mode selection unit may determine whether the audio signal is the LEN. When the audio signal is the LEN, the mode selection unit may encode the audio signal into an LEN mode by applying an open-loop mode in operation S403. In operation S409, the mode selection unit may select the LEN mode as an optimum encoding mode with respect to the audio signal.

When it is determined that the audio signal is different from the LEN, the mode selection unit may determine whether the audio signal is the noise in operation S404. When it is determined that the audio signal is the noise, the mode selection unit may encode the audio signal by applying a closed-loop mode to a UV mode and a TCX mode in operation S405. That is, the mode selection unit may encode the audio signal, which is the noise, into the UV mode and the TCX mode, compare a signal quality such as a Signal to Noise Ratio (SNR) of the encoded signal, and thereby may select an encoding mode with superior SNR as the optimum encoding mode in operation S409.

When it is determined that the audio signal is different from the noise in operation S404, the mode selection unit may determine whether the audio signal is unvoiced in operation S406. When it is determined that the audio signal is unvoiced, the mode selection unit may apply an adaptive offset value to the signal quality, and apply the closed-loop mode to the UV mode and the TCX mode in operation S407. That is, when the optimum encoding mode is selected by comparing the UV based on the only SNR, a sound quality may be degraded. Accordingly, the offset value may be applied. Also, the mode selection unit may select an encoding mode with a superior SNR as the optimum encoding mode in operation S409.

When it is determined that the audio signal is different from the UV in operation S406, the mode selection unit may determine that the audio signal is the remaining signal, and encode the audio signal into an ACELP mode and a TCX mode using a closed-loop mode in operation S408. In operation S409, the mode selection unit may select an encoding mode with a superior SNR as the optimum encoding mode.

In this instance, the mode selection unit may compare an SNR at a same bit rate with respect to an encoding mode in operation S403, operation S405, operation S407, and operation S409.

FIG. 5 illustrates an example of a configuration of an index, encoded when an ACELP/TCX mode is an optimum encoding mode, according to exemplary embodiments. Specifically, FIG. 5 illustrates the configuration of the index supporting a VBR in a superframe including frames of the ACELP/TCX mode.

Referring to FIG. 5, a single superframe may include four frames. Since eight ACELP core modes may exist as a bit rate mode of the superframe, the ACELP core mode may be represented in three bits. Also, tpd_mode' may indicate a bit field defining an encoding mode for each of the four frames of the superframe. The superframe may correspond to an MC frame of a ‘lpd_channel_stream( )’ described below with reference to FIG. 5. Here, the encoding mode for each of the four frames may be stored as an arrangement ‘mod □’ and have a value between 0 and 3.

A flag indexing unit may index a VBR flag with respect to a superframe including a plurality of frames. The VBR flag may indicate whether information about a bit rate mode set for each frame exists, and the plurality of frames may be set as an optimum indexing mode.

In this instance, when the superframe includes a plurality of frames where an ACELP mode and a TCX mode are set as the optimum indexing mode, the flag indexing unit may index the VBR flag based on whether the bit rate mode for each frame is identical to each other. For example, when the bit rate mode for each frame is identical to each other, the VBR flag may be ‘0’. When the bit rate mode for each frame is not identical to each other, the VBR flag may be ‘1’. That is, the VBR flag of ‘0’ may indicate that the frames included in the superframe are set as a same bit rate mode. Accordingly, an index configuration 501 of FIG. 5 may indicate that at least one frame of the superframe is set as a different bit rate mode. An index configuration 502 may indicate that all the frames of the superframe are set as a same bit rate mode.

An ACELP core mode indexing unit may index the ACELP core mode (ACELP_CORE_MODE) indicating a bit rate mode set in the superframe.

A VBR core mode indexing unit may index a VBR core mode (VBR_CORE_MODE) using the VBR flag and the ACELP core mode. The VBR core mode may indicate the bit rate mode for each frame. For example, as illustrated in FIG. 5, when the superframe includes the plurality of frames where the ACELP mode and the TCX mode are set as the optimum indexing mode, the VBR core mode indexing unit may index a difference between the bit rate mode for each frame and the ACELP core mode as the VBR core mode. When a bit rate mode of the superframe is identical to the ACELP core mode, the VBR core mode may be ‘0’. When the ACELP core mode is one-level higher than the bit rate mode of the superframe, the VBR core mode may be ‘1’. Since the VBR core mode may be determined at every four frames, the VBR core mode may have four bits. Since a VBR flag of the index configuration 502 is ‘0’, a each frame may have same bit in the VBR core mode. Accordingly, encoding to the VBR core mode may not be performed.

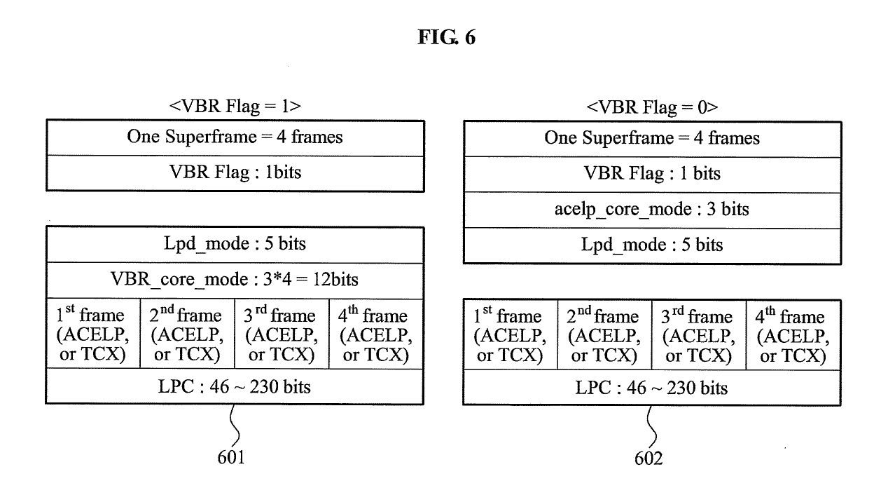

FIG. 6 illustrates another example of a configuration of an index, encoded when an ACELP/TCX mode is an optimum encoding mode, according to exemplary embodiments. Specifically, FIG. 6 illustrates the configuration of the index supporting a VBR in a superframe including frames of the ACELP/TCX mode.

Referring to FIG. 6, a single superframe may include four frames.

A flag indexing unit may index a VBR flag with respect to a superframe including a plurality of frames. Here, the VBR flag may indicate whether information about a bit rate mode set for each frame exists, and the plurality of frames may be set as an optimum indexing mode. In this instance, when the superframe includes a plurality of frames where an ACELP mode and a TCX mode are set as the optimum indexing mode, the flag indexing unit may index the VBR flag based on whether the bit rate mode for each frame is identical to each other.

For example, when the bit rate mode for each frame is identical to each other, the VBR flag may be ‘0’. When the bit rate mode for each frame is not identical to each other, the VBR flag may be ‘1’. That is, the VBR flag of ‘0’ may indicate that the frames included in the superframe are set as a same bit rate mode. Accordingly, an index configuration 601 of FIG. 6 may indicate that at least one frame of the superframe is set as a different bit rate mode. An index configuration 602 may indicate that all the frames of the superframe are set as a same bit rate mode.

Since eight ACELP core modes may exist as a bit rate mode of the superframe, the ACELP core mode may be represented in three bits. However, although the ACELP core mode may not be encoded in the index configuration 601, the ACELP core mode may be encoded in the index configuration 602.

Also, ‘Lpd_mode’ may indicate a bit field defining an encoding mode for each of the four frames of the superframe. The superframe may correspond to an AAC frame of a ‘lpd_channel_stream( )’ described below with reference to FIG. 6. Here, the encoding mode for each of the four frames may be stored as an arrangement ‘mod □’ and have a value between 0 and 3.

An ACELP core mode indexing unit may index the ACELP core mode (ACELP_CORE_MODE) indicating a bit rate mode set in the superframe.

A VBR core mode indexing unit may index a VBR core mode (VBR_CORE_MODE) using the VBR flag and the ACELP core mode. The VBR core mode may indicate the bit rate mode for each frame. For example, as illustrated in FIG. 6, when the superframe includes the plurality of frames where the ACELP mode and the TCX mode are set as the optimum indexing mode, the VBR core mode indexing unit may index a scheme to represent the bit rate mode for each frame as the VBR core mode.

In this instance, eight bit rate modes may be set for the frames, three bits may be assigned for each frame. Also, since the superframe includes the four frames, the VBR core mode may be a total of 12 bits (3*4).

Since a bit rate mode set for each frame is identical in the index configuration 602, the ACELP core mode may be determined as a same value. Also, since the eight bit rate modes are set, the ACELP core mode has three bits. Also, since a same bit rate mode may be set for each frame in the index configuration 602, encoding to the VBR core mode may not be performed.

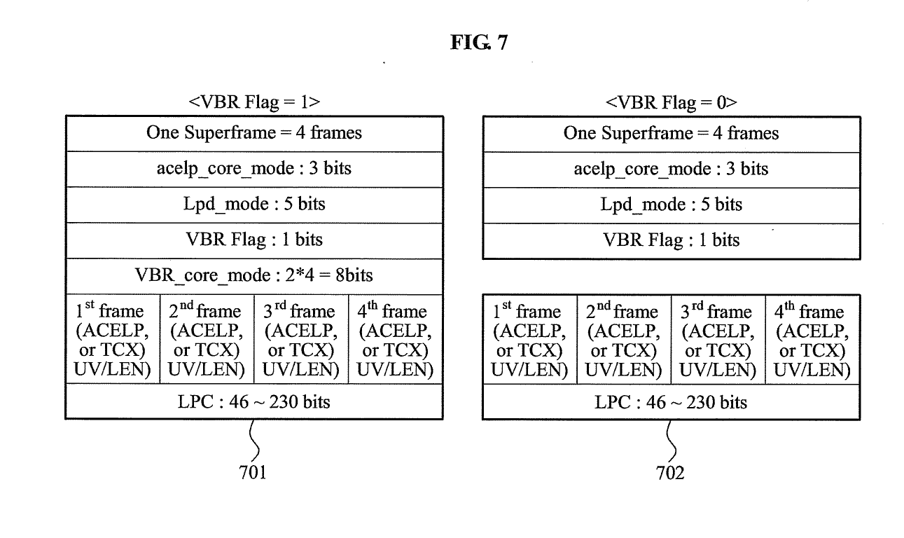

FIG. 7 illustrates an example of a configuration of an index, encoded when an ACELP/TCX/UV/LEN mode is an optimum encoding mode, according to exemplary embodiments. Specifically, FIG. 7 illustrates the configuration of the index supporting a VBR in a superframe including frames of the ACELP/TCX/UV/LEN mode.

Referring to FIG. 7, a single superframe may include four frames. A flag indexing unit may index a VBR flag with respect to a superframe including a plurality of frames. Here, the VBR flag may indicate whether information about a bit rate mode set for each frame exists, and the plurality of frames may be set as an optimum indexing mode. In this instance, when the superframe includes a plurality of frames where an ACELP mode and a TCX mode are set as the optimum indexing mode, the flag indexing unit may index the VBR flag based on whether the bit rate mode for each frame is identical to each other.

For example, when the bit rate mode for each frame is identical to the ACELP core mode, the VBR flag may be ‘0’. When the bit rate mode for each frame is not identical to the ACELP core mode, the VBR flag may be ‘1’. That is, the VBR flag of ‘0’ may indicate that the frames included in the superframe are set as a same bit rate mode. Accordingly, an index configuration 701 of FIG. 7 may indicate that at least one frame of the superframe is set as a different bit rate mode. An index configuration 702 may indicate that all the frames of the superframe are set as a same bit rate mode.

An ACELP core mode indexing unit may index the ACELP core mode (ACELP_CORE_MODE) indicating a bit rate mode set in the superframe. Since eight ACELP core modes may exist as a bit rate mode of the superframe, the ACELP core mode may be represented with three bits.

Also, ‘Lpd_mode’ may indicate a bit field defining an encoding mode for each of the four frames of the superframe. The superframe may correspond to an AAC frame of a ‘lpd_channel_stream( )’ to be described in FIG. 7. Here, the encoding mode for each of the four frames may be stored as an arrangement ‘mod □’ and have a value between 0 and 3.

A VBR core mode indexing unit may index a VBR core mode (VBR_CORE_MODE) using the VBR flag and the ACELP core mode. The VBR core mode may indicate the bit rate mode for each frame. For example, as illustrated in FIG. 7, when the superframe includes the plurality of frames where the ACELP mode, the TCX mode, the UV mode, and the LEN mode are set as the optimum indexing mode, the VBR core mode indexing unit may index the VBR core mode using a difference and an index value. The difference may be between the ACELP core mode and a bit rate mode of the ACELP mode and the TCX mode for each frame.

In this instance, the VBR core mode of ‘0’ may indicate that a bit rate mode of the superframe is identical to the bit rate mode for each frame. Also, the VBR core mode of ‘1’ may indicate that the bit rate mode for each frame is one-level higher than the bit rate mode of the superframe.

The index configuration 701 may include the VBR core mode. The VBR core mode may include a value determining whether the UV/LEN mode is included and a value indicating a result of comparing the bit rate mode of the superframe and the bit rate mode for each frame, and the VBR core mode may be represented as two bits. The index configuration 702 may not include the VBR core mode, since the bit rate mode of the superframe is identical to the bit rate mode for each frame in the index configuration 702.

According to exemplary embodiments, a decoding apparatus using a VBR may extract an audio signal by decoding with reference to the encoded indexes in FIG. 5 through FIG. 7 in reverse of encoding.

For example, an index decoding apparatus may decode an index where a bit rate mode is encoded. In this instance, the index may include a VBR flag, an ACELP core mode, and a VBR core mode. The VBR flag may indicate whether information about a bit rate mode set for each frame exists with respect to a superframe including a plurality of frames. Here, the plurality of frames may be set as an optimum indexing mode. The ACELP core mode may indicate a bit rate mode set for the superframe. The VBR core mode may indicate a bit rate mode for each frame.

FIG. 8 illustrates a block diagram of a configuration of a Unified Speech and Audio Coding (USAC) apparatus that encodes a speech and an audio signal according to exemplary embodiments.

Referring to FIG. 8, the USAC apparatus that encodes a speech and an audio signal may include a frequency domain encoding unit 801 and an LP domain encoding unit 802. Also, the USAC apparatus may include a signal classification unit 803, a stereo encoding unit 804, a high frequency encoding unit 805, a first bit rate determination unit 806, a quantization unit 813, a lossless encoding unit 814, and a multiplexing unit 815. In this instance, the LP domain encoding unit 802 may include a pre-processing unit 807, an LP analysis unit 808, a second bit rate determination unit 809, an LP coefficient quantization unit 810, a TCX mode encoding unit 811, and an ACELP/UV/LEN mode encoding unit 812.

The signal classification unit 803 may classify an input signal based on a characteristic of the input signal. The stereo encoding unit 804 may encode a stereo signal when the input signal is a stereo signal. The high frequency encoding unit 805 may encode a high frequency of the input signal.

The first bit rate determination unit 806 may determine an optimum bit rate per superframe with respect to the input signal, using a bit reservoir and a basic bit rate based on a target bit rate. In this instance, the first bit rate determination unit 806 may determine the optimum bit rate per superframe to perform encoding in the frequency domain encoding unit 801 and the LP domain encoding unit 802.

For example, the first bit rate determination unit 806 may set the basic bit rate that does not exceed the target bit rate, update the bit reservoir using a previously used bit amount, and determine the optimum bit rate per superframe based on the basic bit rate and the bit reservoir.

The frequency domain encoding unit 801 may encode the input signal in a frequency domain using frequency transform such as a Fourier Transform, and the like.

The LP domain encoding unit 802 may encode the input signal in an LP domain. Referring to FIG. 8, the LP domain encoding unit 802 may include the pre-processing unit 807, the LP analysis unit 808, the second bit rate determination unit 809, the LP coefficient quantization unit 810, the TCX mode encoding unit 811, and the ACELP/UV/LEN mode encoding unit 812.

The pre-processing unit 807 may adjust a frequency characteristic to encode an audio signal by removing an undesired frequency component from an input signal and by filtering.

The LP analysis unit 808 may transform an LP coefficient into a value which is appropriate for quantization such as an ISF or a LSF. The LP coefficient quantization unit 810 may perform quantization using a variety of quantization schemes such as a vector quantizer.

The second bit rate determination unit 809 may determine an optimum bit rate per frame using the optimum bit rate per superframe. For example, the second bit rate determination unit 809 may determine a target bit rate for each frame using the optimum bit rate per superframe. Also, the second bit rate determination unit 809 may calculate a local bit reservoir using a bit stored for each frame, and determine the optimum bit rate per frame using the target bit rate for each frame and the local bit reservoir. Also, the second bit rate determination unit 809 may determine the optimum bit rate per frame using encoding mode information of previous frames.

That is, the USAC apparatus may determine the optimum bit rate per superframe, including a plurality of frames, and the optimum bit rate per frame, and thereby may perform encoding more precisely.

Also, the LP domain decoding unit 802 may determine an optimum encoding mode appropriate for the audio signal based on the determined optimum bit rate. For example, the LP domain decoding unit 802 may determine an optimum group of an encoding mode with respect to the audio signal by applying an open-loop mode based on a characteristic of the audio signal, and select an optimum encoding mode by applying a closed-loop mode to the encoding mode included in the optimum group.

In this instance, the audio signal may be classified into an LEN, a UV, a noise, and a remaining signal. The optimum encoding mode may be determined by applying the open-loop mode or the closed-loop mode to the classified signal. In this instance, the closed-loop mode may encode a frame of the audio signal in a same bit rate with respect to the encoding mode included in the optimum group, and select the optimum encoding mode by comparing a signal quality of the encoded audio signal.

For example, when the audio signal is unvoiced, the LP domain decoding unit 802 may select the optimum encoding mode using the closed-loop mode by applying an adaptive offset value to the signal quality of the encoded audio signal. In this instance, the selected optimum encoding mode may be a TCX mode, an ACELP mode, an LEN mode, and a UV mode.

The TCX mode encoding unit 811 may encode the input signal into a TCX mode. The ACELP/UV/LEN mode encoding unit 812 may encode the input signal into the ACELP/UV/LEN mode according to the selected encoding mode.

The quantization unit 813 may quantize the encoded signal. The lossless encoding unit 814 may losslessly encode the quantized input signal. The multiplexing unit 815 may multiplex a result of the stereo encoding unit 804, the high frequency encoding unit 805, the LP coefficient quantization unit 810, the ACELP/UV/LEN mode encoding unit 812, and the lossless encoding unit 814, and thereby may generate a bitstream. In this instance, the bitstream may include information which is obtained by indexing information about a bit rate per superframe or per frame of the encoded signal. For example, the information about a bit rate may include information which is obtained by indexing about a VBR flag, an ACELP core mode, and a VBR core mode. The VBR flag may indicate whether information about a bit rate mode set for each frame exists. The ACELP core mode may indicate a bit rate mode which is set for the superframe. Also, the VBR core mode may indicate a bit rate mode for each frame.

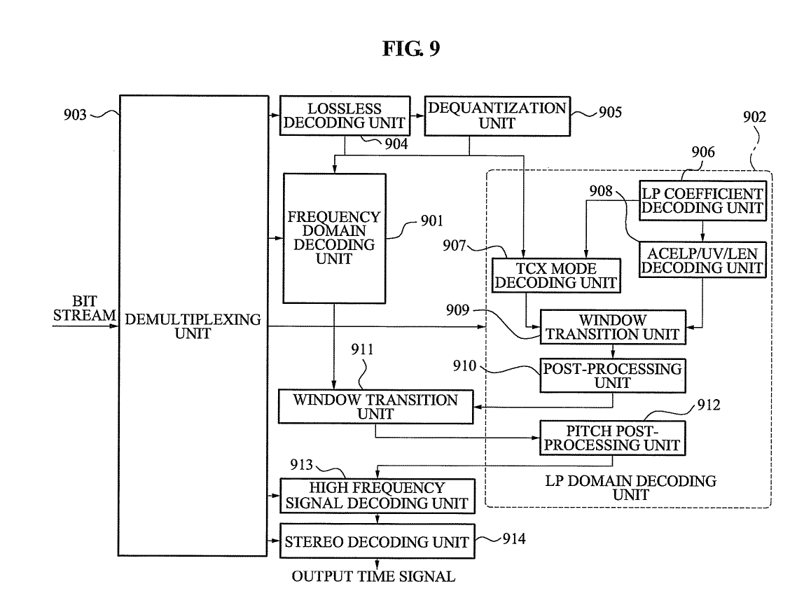

FIG. 9 illustrates a block diagram of a configuration of an USAC apparatus that decodes a speech and an audio signal according to exemplary embodiments.

Referring to FIG. 9, the USAC that decodes a speech and an audio signal may include a frequency domain decoding unit 901 and an LP domain decoding unit 902. Also, the USAC apparatus may include a demultiplexing unit 903, a lossless decoding unit 904, a dequantization unit 905, a window transition unit 911, a high frequency signal decoding unit 913, and a stereo decoding unit 914. The USAC that decodes a speech and an audio signal may be operated in a reverse manner to an USAC that encodes a speech and an audio signal.

The demultiplexing unit 903 may demultiplex a bitstream. In this instance, the bitstream may include information encoded by the USAC that encodes a speech and an audio signal. Also, the bitstream may include information which is obtained by indexing information about a bit rate per superframe or per frame of the encoded signal. For example, the information about a bit rate may include information which is obtained by indexing about a VBR flag, an ACELP core mode, and a VBR core mode. The VBR flag may indicate whether information about a bit rate mode set for each frame exists. The ACELP core mode may indicate a bit rate mode which is set for the superframe. Also, the VBR core mode may indicate a bit rate mode for each frame.

A result of the demultiplexing the bitstream may be transmitted to the lossless decoding unit 904, the frequency domain decoding unit 901, the LP domain decoding unit 902, the high frequency signal decoding unit 913, and the stereo decoding unit 914.

The lossless decoding unit 904 may losslessly decode an encoded signal. The dequantization unit 905 may dequantize the losslessly decoded signal, and extract an original signal where quantization is performed.

The frequency domain decoding unit 901 may decode the dequantized signal in a frequency domain. The LP domain decoding unit 902 may decode the dequantized signal in an LP domain.

Referring to FIG. 9, the LP domain decoding unit 902 may include an LP coefficient decoding unit 906, a TCX mode decoding unit 907, an ACELP/UV/LEN mode decoding unit 908, a window transition unit 909, a post-processing unit 910, and a pitch post-processing unit 912.

The LP coefficient decoding unit 906 may decode an LP coefficient with respect to the dequantized signal. The TCX mode decoding unit 907 may decode the dequantized signal into a TCX mode based on a characteristic of the dequantized signal using the LP coefficient. The ACELP/UV/LEN mode decoding unit 908 may decode the dequantized signal according to any one decoding mode of an ACELP mode, a UV mode, an LEN mode based on the characteristic of the dequantized signal using the LP coefficient. Also, the post-processing unit 910 may remove an inappropriate combination of modes that affects a sound quality, and thereby may maximize the sound quality of decoded signal.

The window transition unit 909 may transit to a subsequent frame when a frame of the signal is completed. The pitch post-processing unit 912 may post-process a pitch of the signal by confirming and decoding a pitch index.

The high frequency signal decoding unit 913 may decode a high frequency signal of a signal whose pitch is post-processed. The stereo decoding unit 914 may decode the signal into a stereo signal. When the above-described decoding operations are complete, an output signal may be generated.

The above-described methods according to exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The computer-readable media may also be a distributed network, so that the program instructions are stored and executed in a distributed fashion. The program instructions may be executed by one or more processors or processing devices. The computer-readable media may also be embodied in at least one application specific integrated circuit (ASIC) or Field Programmable Gate Array (FPGA). The described hardware devices may be configured to act as one or more software modules in order to perform the operations of the above-described exemplary embodiments, or vice versa.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. A bit rate determination apparatus that determines a Variable Bit Rate (VBR) to encode an audio signal, the bit rate determination apparatus comprising:
a first bit rate determination unit to determine an optimum bit rate per superframe using a bit reservoir and a basic bit rate based on a target bit rate using at least one processor; and
a second bit rate determination unit to determine an optimum bit rate per frame using the optimum bit rate per superframe.

2. The bit rate determination apparatus of claim 1, wherein the first bit rate determination unit comprises:
a basic bit rate setting unit to set the basic bit rate that does not exceed the target bit rate;
a bit reservoir update unit to update the bit reservoir using a previously used bit amount; and
an optimum bit rate determination unit to determine the optimum bit rate per superframe based on the basic bit rate and the bit reservoir.

3. The bit rate determination apparatus of claim 1, wherein the first bit rate determination unit determines the optimum bit rate per superframe for encoding in a frequency domain or a Linear Prediction (LP) domain.

4. The bit rate determination apparatus of claim 1, wherein the second bit rate determination unit comprises:
a target bit rate determination unit to determine a target bit rate for each frame using the optimum bit rate per superframe;
a bit reservoir calculation unit to calculate a local bit reservoir using a bit stored for each frame; and
a bit rate determination unit to determine the optimum bit rate per frame using the local bit reservoir and the target bit rate for each frame.

5. The bit rate determination apparatus of claim 4, wherein the bit rate determination unit determines the optimum bit rate per frame using encoding mode information of previous frames.

6. An encoding mode selection apparatus, comprising:
a Voice Activity Detection (VAD) unit to analyze a characteristic of an audio signal and to detect a voice activity; and
a mode selection unit, using at least one processor, to determine an optimum group of an encoding mode with respect to the audio signal by applying an open-loop mode based on the characteristic of the audio signal, and to select an optimum encoding mode by applying a closed-loop mode to the encoding mode included in the optimum group,
wherein the encoding mode includes a Transform Coded eXcitation (TCX) mode, an Algebraic Code Excited Linear Prediction (ACELP) mode, a Low-Energy Noise (LEN) mode, and an unvoiced (UV) mode to encode an audio signal according to a superframe including a plurality of frames.

7. The encoding mode selection apparatus of claim 6, wherein the mode selection unit encodes a frame of the audio signal at a same bit rate with respect to the encoding mode included in the optimum group, and applies the closed-loop mode which selects the optimum encoding mode by comparing a signal quality of the encoded audio signal.

8. The encoding mode selection apparatus of claim 7, wherein the mode selection unit selects the LEN mode as the optimum encoding mode by applying the open-loop mode, when the audio signal is a low energy signal, and selects the optimum encoding mode by applying the closed-loop mode based on a type of the audio signal, when the audio signal is different from the low energy signal.

9. The encoding mode selection apparatus of claim 7, wherein, when the audio signal is unvoiced, the mode selection unit selects the optimum encoding mode using the closed-loop mode by applying an adaptive offset value to the signal quality of the encoded audio signal.

10. An index encoding apparatus, comprising:
a flag indexing unit, using at least one processor, to index a VBR flag with respect to a superframe including a plurality of frames, the VBR flag indicating whether information about a bit rate mode which is set for each frame exists, the plurality of frames being set as an optimum indexing mode;
an ACELP core mode indexing unit to index an ACELP core mode indicating a bit rate mode which is set for the superframe; and
a VBR core mode indexing unit to index a VBR core mode using the VBR flag and the ACELP core mode, the VBR core mode indicating the bit rate mode for each frame.

11. The index encoding apparatus of claim 10, wherein, when the superframe includes a plurality of frames where an ACELP mode and a TCX mode are set as the optimum indexing mode, the flag indexing unit indexes the VBR flag based on whether the bit rate mode for each frame is identical to each other.

12. The index encoding apparatus of claim 11, wherein, when the superframe includes the plurality of frames where the ACELP mode and the TCX mode are set as the optimum indexing mode, the VBR core mode indexing unit indexes a difference between the bit rate mode for each frame and the ACELP core mode as the VBR core mode.

13. The index encoding apparatus of claim 11, wherein, when the superframe includes the plurality of frames where the ACELP mode and the TCX mode are set as the optimum indexing mode, the VBR core mode indexing unit indexes a scheme to represent the bit rate mode for each frame as the VBR core mode.

14. The index encoding apparatus of claim 10, wherein, when the superframe includes a plurality of frames where an ACELP mode, a TCX mode, a UV mode, and an LEN mode are set as the optimum indexing mode, the flag indexing unit indexes the VBR flag based on whether the bit rate mode for each frame is identical to the ACELP core mode.

15. The index encoding apparatus of claim 14, wherein, when the superframe includes a plurality of frames where the ACELP mode, the TCX mode, the UV mode, and the LEN mode are set as the optimum indexing mode, the VBR core mode indexing unit indexes the VBR core mode using a difference and an index value, the index value indicating the UV mode and the LEN mode, and the difference being between the ACELP core mode and a bit rate mode of the ACELP mode and the TCX mode for each frame.

16. An audio signal encoding apparatus, comprising:
a first bit rate determination unit to determine an optimum bit rate per superframe using a bit reservoir and a basic bit rate based on a target bit rate using at least one processor;
a VAD unit to analyze a characteristic of an audio signal and to detect a voice activity;
a second bit rate determination unit to determine an optimum bit rate per frame using the optimum bit rate per superframe;
a mode selection unit to determine an optimum group of an encoding mode with respect to the audio signal by applying an open-loop mode based on the characteristic of the audio signal, and to select an optimum encoding mode by applying a closed-loop mode to the encoding mode included in the optimum group; and
an index encoding unit to index a bit rate based on the optimum encoding mode.

17. The audio signal encoding apparatus of claim 16, wherein the first bit rate determination unit comprises:
a basic bit rate setting unit to set the basic bit rate that does not exceed the target bit rate;
a bit reservoir update unit to update a bit reservoir using a previously used bit amount; and
an optimum bit rate determination unit to determine the optimum bit rate per superframe based on the basic bit rate and the bit reservoir.

18. The audio signal encoding apparatus of claim 16, wherein the second bit rate determination unit comprises:
a target bit rate determination unit to determine a target bit rate for each frame using the optimum bit rate per superframe;
a bit reservoir calculation unit to calculate a local bit reservoir using a bit stored for each frame; and
a bit rate determination unit to determine the optimum bit rate per frame using the local bit reservoir and the target bit rate for each frame.

19. The audio signal encoding apparatus of claim 18, wherein the bit rate determination unit determines the optimum bit rate per frame using encoding mode information of previous frames.

20. The audio signal encoding apparatus of claim 16, wherein the mode selection unit encodes a frame of the audio signal in a same bit rate with respect to the encoding mode included in the optimum group, and applies the closed-loop mode which selects the optimum encoding mode by comparing a signal quality of the encoded audio signal.

21. The audio signal encoding apparatus of claim 16, wherein the index encoding unit comprises:
a flag indexing unit to index a VBR flag with respect to a superframe including a plurality of frames, the VBR flag indicating whether information about a bit rate mode set for each frame exists, the plurality of frames being set as an optimum indexing mode;
an ACELP core mode indexing unit to index an ACELP core mode indicating a bit rate mode set in the superframe; and
a VBR core mode indexing unit to index a VBR core mode using the VBR flag and the ACELP core mode, the VBR core mode indicating the bit rate mode for each frame.

22. An index decoding apparatus comprising a decoding unit which uses at least one processor to decode an index where a bit rate mode is encoded, wherein the index comprises:
a VBR flag to indicate whether information about a bit rate mode set for each frame exists with respect to a superframe including a plurality of frames, the plurality of frames being set as an optimum indexing mode;
an ACELP core mode to indicate a bit rate mode which is set for the superframe; and
a VBR core mode to indicate a bit rate mode for each frame.

23. The index decoding apparatus of claim 22, wherein, when the superframe includes a plurality of frames where an ACELP mode and a TCX mode are set as the optimum indexing mode, the VBR flag indicates a value determined based on whether the bit rate mode for each frame is identical to each other.

24. The index decoding apparatus of claim 23, wherein, when the superframe includes the plurality of frames where the ACELP mode and the TCX mode are set as the optimum indexing mode, the VBR core mode indicates a difference between the bit rate mode for each frame and the ACELP core mode.

25. The index decoding apparatus of claim 23, wherein, when the superframe includes the plurality of frames where the ACELP mode and the TCX mode are set as the optimum indexing mode, the VBR core mode indicates a scheme to represent the bit rate mode for each frame.

26. The index decoding apparatus of claim 22, wherein, when the superframe includes a plurality of frames where an ACELP mode, a TCX mode, a UV mode, and an LEN mode are set as the optimum indexing mode, the VBR flag indicates whether the bit rate mode for each frame is identical to the ACELP core mode.

27. The index decoding apparatus of claim 26, wherein, when the superframe includes a plurality of frames where the ACELP mode, the TCX mode, the UV mode, and the LEN mode are set as the optimum indexing mode, the VBR core mode indicates a value determined by a difference and an index value, the index value indicating the UV mode and the LEN mode, and the difference being between the ACELP core mode and a bit rate mode of the ACELP mode and the TCX mode for each frame.

28. A Unified Speech and Audio Coding (USAC) apparatus that encodes a speech and an audio signal, the USAC apparatus comprising:
a signal classification unit to classify an input signal using at least one processor;
a stereo encoding unit to encode a stereo signal when the input signal is a stereo signal;
a high frequency encoding unit to encode a high frequency of the input signal;
a first bit rate determination unit to determine an optimum bit rate per superframe, when the input signal is encoded in a frequency domain or an LP domain;
a frequency domain encoding unit to encode the input signal in the frequency domain;
an LP domain encoding unit to encode the input signal in the LP frequency domain;
a quantization unit to quantize the input signal, encoded in the frequency domain or the LP domain; and
a lossless encoding unit to losslessly encode the quantized input signal.

29. The USAC apparatus of claim 28, wherein the LP domain encoding unit comprises:
a pre-processing unit to pre-process the input signal;
an LP analysis unit to perform LP analysis with respect to the pre-processed input signal;
an LP coefficient quantization unit to extract an LP coefficient through the LP analysis and quantize the extracted LP coefficient;
a second bit rate determination unit to determine an optimum bit rate per frame using the optimum bit rate per superframe, the superframe including a plurality of frames;
a TCX mode encoding unit to encode the input signal into a TCX mode based on a characteristic of the input signal using the LP coefficient and the optimum bit rate; and
an ACELP/UV/LEN mode encoding unit to encode the input signal according to any one encoding mode of an ACELP mode, a UV mode, an LEN mode based on the characteristic of the input signal using the LP coefficient and the optimum bit rate.

30. A USAC apparatus that decodes a speech and an audio signal, the USAC apparatus comprising:
a lossless decoding unit to losslessly decode an encoded signal;
a dequantization unit to dequantize the losslessly decoded signal using at least one processor;
a frequency domain decoding unit to decode the dequantized signal in a frequency domain;
an LP domain decoding unit to decode the dequantized signal in an LP frequency domain;
a high frequency signal decoding unit to decode a high frequency signal of the signal decoded in the frequency domain and the LP domain; and
a stereo decoding unit to decode the signal, decoded in the frequency domain and the LP domain, into a stereo signal.

31. The USAC apparatus of claim 30, wherein the LP domain decoding unit compries:
an LP coefficient decoding unit to decode an LP coefficient with respect to the dequantized signal;
a TCX mode decoding unit to decode the dequantized signal into a TCX mode based on a characteristic of the dequantized signal using the LP coefficient; and
an ACELP/UV/LEN mode decoding unit to decode the dequantized signal according to any one decoding mode of an ACELP mode, a UV mode, an LEN mode based on the characteristic of the dequantized signal using the LP coefficient.

32. A bit rate determination method that determines a VBR to encode an audio signal, the bit rate determination method comprising:
determining an optimum bit rate per superframe using a bit reservoir and a basic bit rate based on a target bit rate; and
determining an optimum bit rate per frame using the optimum bit rate per superframe, wherein the method is performed using at least one processor.

33. The bit rate determination method of claim 32, wherein the determining of the optimum bit rate per superframe comprises:
setting the basic bit rate that does not exceed the target bit rate;
updating the bit reservoir using a previously used bit amount; and
determining the optimum bit rate per superframe based on the basic bit rate and the bit reservoir.

34. The bit rate determination method of claim 32, wherein the determining of the optimum bit rate per frame comprises:
determining a target bit rate for each frame using the optimum bit rate per superframe;
calculating a local bit reservoir using a bit stored for each frame; and
determining the optimum bit rate per frame using the local bit reservoir and the target bit rate for each frame.

35. An encoding mode selection method, comprising:
analyzing a characteristic of an audio signal and detecting a voice activity; and
determining an optimum group of an encoding mode with respect to the audio signal by applying an open-loop mode based on the characteristic of the audio signal, and selecting an optimum encoding mode by applying a closed-loop mode to the encoding mode included in the optimum group,
wherein the encoding mode includes a TCX mode, an ACELP mode, a LEN mode, and a UV mode to encode an audio signal according to a superframe including a plurality of frames, and
wherein the method is performed using at least one processor.

36. The encoding mode selection method of claim 35, wherein the selecting comprises:
encoding a frame of the audio signal at a same bit rate with respect to the encoding mode included in the optimum group; and
applying the closed-loop mode which selects the optimum encoding mode by comparing a signal quality of the encoded audio signal.

37. An index encoding method, comprising:
indexing a VBR flag with respect to a superframe including a plurality of frames, the VBR flag indicating whether information about a bit rate mode set for each frame exists, the plurality of frames being set as an optimum indexing mode;
indexing an ACELP core mode indicating a bit rate mode set for the superframe; and
indexing a VBR core mode using the VBR flag and the ACELP core mode, the VBR core mode indicating the bit rate mode for each frame,
wherein the method is performed using at least one processor.

38. The index encoding method of claim 37, wherein, when the superframe includes a plurality of frames where an ACELP mode and a TCX mode are set as the optimum indexing mode, the indexing of the VBR flag indexes the VBR flag based on whether the bit rate mode for each frame is identical to each other, and
the indexing of the VBR core mode indexes a difference between the bit rate mode for each frame and the ACELP core mode, or a scheme to represent the bit rate mode for each frame, as the VBR core mode.

39. The index encoding method of claim 37, wherein, when the superframe includes a plurality of frames where an ACELP mode, a TCX mode, a UV mode, and an LEN mode are set as the optimum indexing mode, the indexing of the VBR flag indexes the VBR flag based on whether the bit rate mode for each frame is identical to the ACELP core mode, and
the indexing of the VBR core mode indexes the VBR core mode using a difference and an index value, the index value indicating the UV mode and the LEN mode, and the difference being between the ACELP core mode and a bit rate mode of the ACELP mode and the TCX mode for each frame.

40. An audio signal encoding method, comprising:
determining an optimum bit rate per superframe using a bit reservoir and a basic bit rate based on a target bit rate;
analyzing a characteristic of an audio signal and detecting a voice activity;
determining an optimum bit rate per frame using the optimum bit rate per superframe;
determining an optimum group of an encoding mode with respect to the audio signal by applying an open-loop mode based on the characteristic of the audio signal, and selecting an optimum encoding mode by applying a closed-loop mode to the encoding mode included in the optimum group; and
indexing a bit rate based on the optimum encoding mode,
wherein the method is performed using at least one processor.

41. At least one computer-readable recording medium storing a program for implementing a bit rate determination method that determines a VBR to encode an audio signal, the bit rate determination method comprising:
determining an optimum bit rate per superframe using a bit reservoir and a basic bit rate based on a target bit rate; and
determining an optimum bit rate per frame using the optimum bit rate per superframe.
